(19) United States
(12) Patent Application Publication
(10) Pub. No.: US 2008/0062331 A1
(43) Pub. Date: Mar. 13, 2008

(54) DIGITAL TELEVISION SYSTEM WITH LCD TV CONTROLLER AND DIGITAL TV BACKEND CONTROLLER

(75) Inventors: MING-JANE HSIEH, TAIPEI CITY (TW); CHIEN-HUA HSIEH, TAIPEI COUNTY (TW); JIN-SHENG GONG, HSINCHU CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: REALTEK SEMICONDUCTOR CORP., HSINCHU (TW)

(21) Appl. No.: 11/852,665

(22) Filed: Sep. 10, 2007

(30) Foreign Application Priority Data
Sep. 11, 2006 (TW) 095133408

(51) Int. Cl. H04N 5/455

(52) U.S. Cl. 348/726; 348/E05.113

(57) ABSTRACT

A DTV system with a LCD TV controller and a DTV backend controller is disclosed. The LCD TV controller is applied to receive a decoded video signal from an analog TV signal source. And the LCD TV controller decodes, scales and executes the image process on the video signal according to the display form of the LCD TV. A DTV backend controller is applied to receive a decoded video signal from a digital TV signal source. After decoding the video signal, the DTV backend controller outputs the video signal to the LCD TV controller. The LCD TV controller decode, scales and executes the image process on the video signal according to the display form of the LCD TV. And the LCD TV controller transmits the video signal back to the DTV backend controller for executing the OSD process on the video signal by the DTV backend controller. The video signal is transmitted to a display panel for displaying a corresponding video image. Since the control and generation of OSD are processed at the backend of the total process flow, the drawbacks of the conventional technology can be solved.

### FIELD OF THE INVENTION

The present invention relates to a digital TV system, and more particularly to a digital TV system with a LCD TV control chip and a digital TV backend control chip.

### BACKGROUND OF THE INVENTION

The current displays, such as CRT, LCD TV or plasma TV, provide the OSD function by generating several controllable information or icons, so that the display can show its current status when user changes channel, adjusts volume or resolution of TV. Therefore, an OSD control chip or an embedded OSD circuit in the control circuit of display becomes the key point of information display in the human-machine Interface. In addition, control and generation of the OSD in the TV system are executed in the DTV backend control chip since the DTV backend control chip has a powerful graphic engine.

It is noticed that since the OSD image is generally located on the top layer of the screen, the circuit related to control and generation of the OSD should be configured at the back end of the whole image process flow. Being generated before the de-interlacing process, the OSD image information is usually a corresponsively still image, and being blended with the video signal having motion signal usually results in the difficulty in motion detection during the de-interlace process. The drawback mentioned above will cause low image quality.

### SUMMARY OF THE INVENTION

One objective of the present invention is to provide a DTV system having a DTV backend controller with a built-in OSD control circuit to prevent from the drawbacks of the conventional digital TV.

One objective of the present invention is providing a DTV system with a LCD TV controller and a DTV backend controller. The LCD TV controller is applied to receive a decoded video signal from an analog TV signal source. And the LCD TV controller executes the decoding, scaling and resolution and color control process on the video signal according to a display form of the LCD TV.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a sketch map of the DTV in accordance with the present invention;

FIG. 2 is a digital video signal processing flow chart of the invention; and

FIG. 3 is a digital video signal and analog video signal processing flow chart of the invention.

### DETAILED DESCRIPTION OF THE PREFERRED EMBODIMENTS

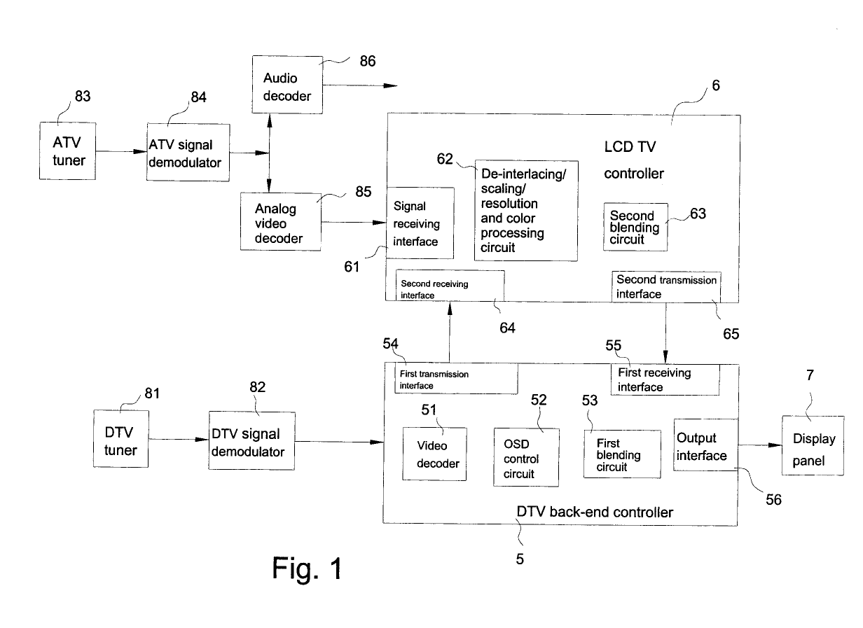

As shown in FIG. 1, the digital TV system includes an analog front end circuit for receiving a DTV signal, a Digital TV backend controller 5, an analog TV receiver for receiving an analog TV signal, a LCD TV controller 6 and a display panel 7. The separated parts mentioned above are implemented by packaging in one or two integrated circuit chips respectively, and these chips are integrated in one or several printed circuit boards. In the future, the parts mentioned above might be totally or partly implemented in dies of a chip. For example, a digital TV controller integrating the main functions of the DTV backend controller 5 and the LCD TV controller 6 with other functions in a chip can be a possible implementation.

In FIG. 1, parts related to the features of the embodiment of the invention will be illustrated in detail and illustrations to other conventional parts of the digital TV system will be omitted for brevity. In this embodiment, a Digital TV tuner 81, abbreviated DTV tuner, and a Digital TV signal demodulator 82, abbreviated DTV signal demodulator, are configured between the DTV backend controller 5 and the analog front end circuit (not shown), so that the DTV backend controller 5 can receive a transport packet stream which has been demodulated and packetized. The DTV backend controller 5 separates the video/audio/system (V/A/SI) information from the transport packet stream, and decodes the video signal and the audio signal respectively. Then, the decoded video signal is transmitted to the LCD TV controller 6 for further process.

In this embodiment, the DTV backend controller 5 includes a video decoder 51, such as a MPEG2 decoder, an OSD control circuit 52, a blending circuit 53, a first transmission interface 54, such as the BT1120, a first receiving interface 55, such as the LVDS, and an output interface 56, such as the LVDS. The components in the DTV backend controller 5 are coupled to each other through an internal bus. The first transmission interface 54 and the first receiving interface 55 are coupled to the LCD TV controller 6, and the output interface 56 is coupled to the display panel 7. The components of the DTV backend controller 5 mentioned above are well known thus the detailed illustration is omitted.

In the embodiment, an ATV tuner 83, an ATV signal demodulator 84 and an analog video decoder 85 are configured between the ATV receiver and the LCD TV controller 6, so that the LCD TV controller 6 can receive a demodulated and decoded video signal from an analog TV signal source, and the demodulated and decoded audio signal from the analog TV signal source can be transmitted to an audio decoder 86 for following process before being broadcasted by an external audio output device, such as a speaker. The implementation of the technology mentioned above is well known thus the detailed illustration is omitted.

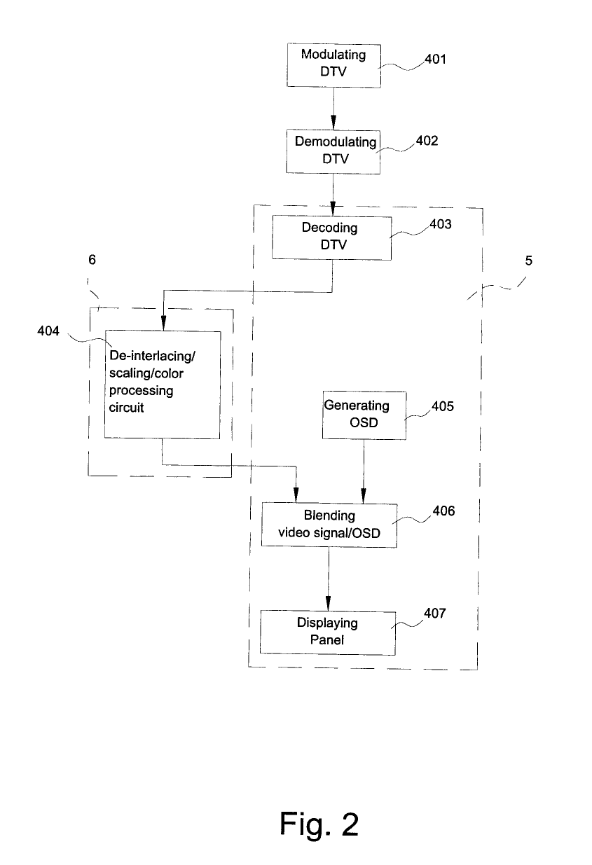

In the embodiment, the LCD TV controller 6 includes a signal receiving interface 61, such as the CCIR-656, a de-interlacing/scaling/resolution and color process circuit, abbreviated de-interlace processor 62, a second blending circuit 63, a second receiving interface 64, such as the BT1120, and a second transmission interface 65, such as the LVDS. The signal receiving interface 61 enables the LCD TV controller 6 to receive the analog video signal, which has been demodulated and decoded, from the analog TV signal source. The second receiving interface 64 is applied to receive the digital video signal which has been decoded and processed. Please refer to FIG. 1 and FIG. 2 respectively, the analog or digital video signal is transmitted to the LCD TV controller 6, and the LCD TV controller 6 de-interlaces the transmitted analog or digital video signal by the de-interlace processor 62 to transform the interlaced signal to the progressive signal suitable for the display panel 7.

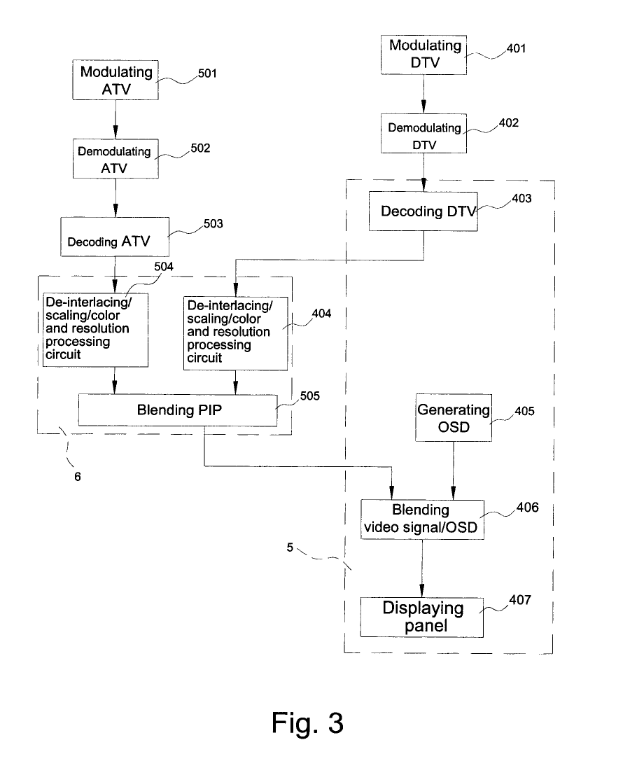

If the user requires to switch the screen into PIP (picture in picture) mode, as shown in FIG. 3, the LCD TV controller 6 blends the digital video signal with the analog video signal to generate a PIP image by the PIP processor, where the digital video signal is transmitted from the DTV backend controller 5 and the analog video signal is transmitted from the ATV receiver. And then the PIP image is transmitted to the DTV backend controller 5 through the second transmission interface 65 and the first receiving interface 55. Finally, the first blending circuit 53 blends the video signal processed by each component mentioned above with the OSD image information from the DTV backend controller 5 and transmits the blended signal to the panel 7 for display.

For understanding the process steps in accordance with the present invention in detail, as shown in FIG. 2, each step of processing and displaying digital video signal are illustrated as following

Step 401: Modulating the digital TV signal.

Step 402: Demodulating the digital TV signal so that the DTV backend controller 5 can receive a transport packet stream which has been demodulated and packetized.

Step 403: Decoding the transport packet stream to generate the digital video signal, and transmit the digital video signal to the LCD TV controller 6 for further process.

Step 404: De-interlacing the digital video signal, and transmitting it back to the DTV backend controller 5.

Step 405: Generating the OSD image information.

Step 406: Blending the de-interlaced digital video signal with the OSD image information to generate a blended signal.

Step 407: Transmitting the blended signal to the display panel for display.

Please refer to FIG. 3, when combining the analog video signal for the picture in picture function, the following steps should be executed before the step 405 mentioned above:

Step 501: Modulating the analog TV signal.

Step 502: Demodulating the analog TV signal.

Step 503: Transmitting the analog video signal to the LCD TV controller 6 for further process after the analog video signal is decoded.

Step 504: De-interlacing the analog video signal.

Step 505: Generating the PIP image containing the de-interlaced analog video signal and the digital video signal, and transmitting the PIP image to the DTV backend controller 5.

Then, continuing executing the step 405˜step 407 can make the blending video signal being transmitted to display panel 7 for display.

It is noted is that the analog video signal received from the ATV receiver also should be de-interlaced. The sequence of the PIP process and the other processes such as de-interlace is tunable by the designer and is not limiting the scope of the invention. Meanwhile, the PIP image also can be synthesized by several digital video signals and/or several analog signals. It is noted that that the image process performed by the LCD TV control 6 before de-interlacing process or the second blending circuit 63 or after the second blending circuit 63, such as scaling or color processing, are well known, the combination of utilizing the image processes being variable, and thus the scope of the present invention is not limited to the above-mentioned embodiments.

The LCD TV controller 6, the DTV backend controller 5 can also be implemented by ASIC, dedicated hardwired circuitry, microprocessor or general-purpose processing circuitry to meet the designing requirements. In addition, the present invention can not only be applied for LCD, flat plat displays, such as LCOS and plasma thin-film panel, and non-flat digital TV displays.

In the embodiment of the digital TV system in accordance with the present invention, the OSD image information generated by the DTV backend controller 5 is not blended with the video signal until the digital video signal or the analog video signal until the OSD image information is de-interlaced, and/or PIP processed, and transmitted back to the DTV backend controller 5. Then the video signal and the OSD image information are blended to generate a blended signal.

Although the embodiment above refers to the local OSD image information, the present invention also can be applied to the system information (SI) which is transmitted with the digital TV signal from the far-end terminal. The system information usually includes a still image, such as the subtitle at a corner of the screen, a time-corresponsively still image, such as the closed caption which is switched over an interval of several seconds following the playing of program, or a space-corresponsively still image, such as the scrolling or text crawling which locates in part of the screen and moves in a steady velocity. The display processor should includes a SI processor to receive the separated SI information and generate a SI image signal corresponding to the separated SI information, and deliver the SI image signal to the LCD TV controller 6. Then, the SI image signal is blended with the video signal which has been de-interlaced.

The DTV backend controller 5 and the LCD TV controller 6 are implemented in individual IC chips, and the transmission interface is realized by the CCIR656 or DVI. However, a combination of the DTV backend controller 5, the LCD TV controller 6 and other components of the digital TV system in one chip also belongs to the scope of the present invention, meaning that as long as the still or corresponsively still images, such as the OSD information or the SI signal, are blended with the video signal after the video signal has been de-interlaced or PIP processed, the drawbacks of the conventional apparatus or method could be solved.

While the present invention has been described by way of example and in terms of a preferred embodiment, it is to be understood that the present invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital TV system with a LCD TV controller and a digital TV backend controller comprising:
a LCD TV controller, for receiving a decoded video signal, and processing the decoded video signal according to a display form of a LCD TV;
a digital TV backend controller, for receiving a modulated video signal from a digital TV signal source, decoding the modulated video signal, outputting the decoded modulated video signal to the LCD TV controller, and receiving the video signal generated by the LCD TV controller; and
an on-screen-display(OSD) circuit, installed inside the digital TV backend controller, for executing a OSD process on the video signal before outputting the video signal generated by the digital TV backend controller to a LCD panel.

2. The digital TV system of claim 1, further comprising
an analog TV tuner, for receiving an analog TV signal;
an analog TV signal demodulator, coupled to the analog TV tuner, for demodulating the analog TV signal from the analog TV tuner to obtain a video signal and an audio signal which are comprised in the analog TV signal;
an audio signal decoder, coupled to the analog TV signal demodulator, for receiving and decoding the demodulated audio signal; and
a video signal decoder, coupled to the analog TV signal demodulator and the LCD TV controller, for receiving and decoding the demodulated video signal, and then transmitting the decoded video signal to the LCD TV controller.

3. The digital TV system of claim 1 or claim 2, further comprising:
a digital TV tuner, for receiving a digital TV signal; and
a digital TV signal demodulator, coupled to the digital TV tuner and the digital TV backend controller, for demodulating a digital TV signal from the digital TV tuner, and transmitting the demodulated video signal to the digital TV backend controller.
